(19) United States
(12) Patent Application Publication
(10) Pub. No.: US 2016/0140255 A1
(43) Pub. Date: May 19, 2016

(54) METHOD AND APPARATUS FOR MODELING DEFORMABLE BODY BY FUSING SURFACE PARTICLES AND INTERNAL SKELETAL STRUCTURE

(71) Applicant: Samsung Electronics Co., Ltd., Suwon-si (KR)

(72) Inventors: Jiyeon KIM, Hwaseong-si (KR); Nahyup KANG, Seoul (KR); Hyong Euk LEE, Suwon-si (KR); Hwiryong JUNG, Seoul (KR)

(73) Assignee: Samsung Electronics Co., Ltd., Suwon-si (KR)

(21) Appl. No.: 14/940,542

(22) Filed: Nov. 13, 2015

(30) Foreign Application Priority Data
Nov. 13, 2014 (KR) 10-2014-0158084

(51) Int. Cl. G06F 17/50

(52) U.S. Cl. CPC G06F 17/50

(57) ABSTRACT

Provided is a method and corresponding apparatus to model a deformable body. The method includes obtaining a material property corresponding to an internal skeletal structure of a deformable body. The method calculates a displacement amount of the skeletal structure according to a motion of the deformable body, based on a boundary condition of the skeletal structure, and the material property. The method further calculates displacement amounts of surface particles on a surface of the deformable body, based on the displacement amount of the skeletal structure, and models the deformable body based on the calculated displacement amounts of the surface particles.

### CROSS-REFERENCE TO RELATED APPLICATION(S)

This application claims the benefit under 35 USC 119(a) of Korean Patent Application No. 10-2014-0158084, filed on Nov. 13, 2014, in the Korean Intellectual Property Office, the entire disclosure of which is incorporated herein by reference for all purposes.

### BACKGROUND

1. Field

The following description relates to a method and apparatus to model a deformable body by fusing surface particles and an internal skeletal structure.

2. Description of Related Art

A method to model a deformable body includes a modeling method based on grids and a modeling method based on particles.

In the modeling method based on grids, a physical property is calculated in each of grids. The modeling method includes a finite element method (FEM). In the modeling method based on particles, particles included within a predetermined distance from each other are defined as neighbor particles, and the deformable body is modeled based on the physical property calculated in the neighbor particles. The modeling method based on particles includes a smoothed particle hydrodynamics (SPH) method.

The modeling method based on particles is selected and the modeling is performed by applying a parallel processing algorithm in order to speed up the modeling of deformable body. However, a calculation time may need to be significantly reduced in order to model the deformable body in real time.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In accordance with an embodiment, there is provided a method of modeling a deformable body, the method including: obtaining a material property corresponding to an internal skeletal structure of a deformable body; calculating a displacement amount of the skeletal structure according to a motion of the deformable body, based on a boundary condition of the skeletal structure, and the material property; calculating displacement amounts of surface particles on a surface of the deformable body, based on the displacement amount of the skeletal structure; and modeling the deformable body based on the calculated displacement amounts of the surface particles.

The method may also include generating a geometrical shape model of the deformable body.

The method may also include distributing the surface particles along the surface of the deformable body to represent a shape of the deformable body; and modeling the skeletal structure.

The distributing may include densely distributing the surface particles on an area in which a shape complexity is greater than or equal to a predetermined value, and coarsely distributing the surface particles on an area in which the shape complexity is less than the predetermined value.

The modeling may include modeling the skeletal structure based on a curvature of the surface of the deformable body and a shape of the deformable body.

The modeling may include modeling the skeletal structure by disposing frames at each end of an area in which a curvature change amount of the surface of the deformable body is greater than or equal to a predetermined value.

The modeling may include coarsely modeling the skeletal structure based on at least one of a frame, a mesh, and a particle.

The material property may include information on a parameterized degree of change occurring in each direction in structural bodies of a skeletal structure in response to an external force being applied to the deformable body.

The material property may be obtained from a pre-computation when the skeletal structure of the deformable body is modeled.

The obtaining may include obtaining a virtual material property that enables an actual material property of the deformable body to correspond to the skeletal structure of the deformable body as the material property.

The method may also include obtaining a boundary condition of the skeletal structure.

The boundary condition may include a displacement boundary condition and an external force applied to the deformable body.

The calculating of the displacement amount of the skeletal structure may include based on the material property, calculating a constitutive equation approximating a relationship between the displacement amount of the skeletal structure and an external force applied to the deformable body; and calculating the displacement amount of the skeletal structure using the constitutive equation.

The calculating of the displacement amounts of the surface particles may include determining surface particles that are influenced by a motion of a vertex at which structural bodies configuring the skeletal structure intersect; calculating a stretch amount, a rotation amount, and a translation amount of the vertex according to the motion of the deformable body; and calculating the displacement amounts of the surface particles by applying a result of the calculating to the determined surface particles.

The modeling may include modeling the deformable body by iteratively performing the calculating of the displacement amount of the skeletal structure and the calculating of the displacement amounts of the surface particles based on a time step.

In accordance with an embodiment, there is provided a non-transitory computer-readable storage medium including a program, the program being configured to control a processor to perform the method described above.

In accordance with an embodiment, there is provided an apparatus for modeling a deformable body, the apparatus including: an obtainer configured to obtain a material property corresponding to an internal skeletal structure of the deformable body; a first calculator configured to calculate a displacement amount of the skeletal structure according to a motion of the deformable body, based on a boundary condition of the skeletal structure, and the material property; a second calculator configured to calculate displacement amounts of surface particles of a surface of the deformable body, based on the displacement amount of the skeletal structure; and a modeler configured to model the deformable body based on the calculated displacement amounts of the surface particles.

The apparatus may also include a shape model generator configured to generate geometrical shape model of the deformable body.

The shape model generator may be configured to distribute the surface particles along the surface of the deformable body to represent a shape of the deformable body, and model the skeletal structure based on a curvature of the surface of the deformable body and the shape of the deformable body.

The obtainer may be configured to obtain a virtual material property that enables an actual material property of the deformable body to correspond to the skeletal structure of the deformable body as the material property.

The apparatus may also include a boundary condition obtainer configured to obtain the boundary condition of the skeletal structure.

The second calculator may be configured to determine surface particles that are influenced by a motion of a vertex at which structural bodies configuring the skeletal structure intersect, calculate a stretch amount, a rotation amount, and a translation amount of the vertex according to the motion of the deformable body, and calculate the displacement amounts of the surface particles by applying a result of the calculating to the determined surface particles.

The surface particles may be densely distributed in a high geometrical complexity area including a curve portion.

The modeler may be configured to perform modeling based on a physical property of a motion of a coarse internal skeletal structure of the deformable body, and calculate the displacement amount of the skeletal structure based on a time step.

The modeler may be configured to model the skeletal structure by disposing frames at each end of an area in which a curvature change amount of the surface of deformable body is greater than or equal to a predetermined value.

Other features and aspects will be apparent from the following detailed description, the drawings, and the claims.

### BRIEF DESCRIPTION OF THE DRAWINGS

FIG. 1 is a diagram illustrating an example of modeling a deformable body by fusing surface particles and an internal skeletal structure, in accordance with an embodiment.

FIG. 2 is a flowchart illustrating an example of a method of modeling a deformable body, in accordance with an embodiment.

FIG. 3 is a flowchart illustrating an example of a method of generating a geometrical shape model, in accordance with an embodiment.

FIG. 4 is a flowchart illustrating an example of a method of calculating displacement amounts of surface particles of a deformable body, in accordance with an embodiment.

FIG. 5 is a diagram illustrating an example of a method of calculating displacement amounts of surface particles, in accordance with an embodiment.

FIG. 6 is a flowchart illustrating another example of a method of modeling a deformable body, in accordance with an embodiment.

FIG. 7 is a block diagram illustrating an example of an apparatus for modeling a deformable body, in accordance with an embodiment.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Hereinafter, the examples will be described with reference to the accompanying drawings. Like reference numerals refer to like elements throughout.

Various alterations and modifications may be made to the examples. Here, the examples are not construed as limited to the disclosure and should be understood to include all changes, equivalents, and replacements within the idea and the technical scope of the disclosure.

The terminology used herein is for the purpose of describing particular examples only and is not to be limiting of the examples. As used herein, the singular forms “a”, “an”, and “the” are intended to include the plural forms as well, unless the context clearly indicates otherwise. It will be further understood that the terms “include/comprise” and/or “have” when used in this specification, specify the presence of stated features, integers, steps, operations, elements, components, and/or combinations thereof, but do not preclude the presence or addition of one or more other features, numbers, steps, operations, elements, components, and/or groups thereof.

Unless otherwise defined, all terms including technical and scientific terms used herein have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the examples with reference to the accompanying drawings, like reference numerals refer to like constituent elements and a repeated description related thereto will be omitted. When it is determined detailed description related to a related known function or configuration they may make the purpose of the examples unnecessarily ambiguous in describing the examples, the detailed description will be omitted here.

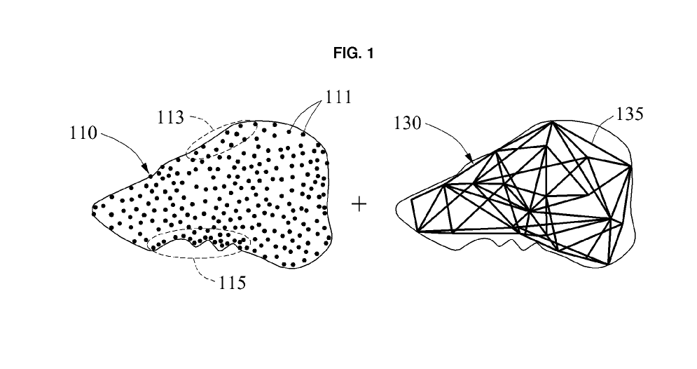

FIG. 1 is a diagram illustrating an example of modeling a deformable body by fusing surface particles and an internal skeletal structure, in accordance with an embodiment.

Referring to FIG. 1, a surface 110 of the deformable body along which surface particles 111 are distributed and a geometrical shape model of the deformable body generated as an internal skeletal structure 130 of the deformable body are illustrated.

In an example, the deformable body is modeled by dividing the surface 110 of the deformable body along which the surface particles 111 are distributed and the internal skeletal structure 130 of the deformable body. Accordingly, a number of particles used to model the deformable body are reduced, thereby reducing a complexity in processing and calculating.

An apparatus to model a deformable body (hereinafter, a “modeling apparatus”) defines an external shape by distributing the sufficient amounts of surface particles 111 to represent a geometrical shape of the deformable body along the surface 110 of the deformable body.

For example, the modeling apparatus densely distributes the surface particles 111 in a high geometrical complexity area 115, such as a curve portion, considering that a shape of the deformable body has many curved portions. The modeling apparatus coarsely distributes the surface particles 111 in a low geometrical complexity area 113, in a relative manner.

The modeling apparatus coarsely represents the inside of the deformable body as the skeletal structure 130. The skeletal structure 130 is modeled based on structural bodies, for example, rod frames 135.

The modeling apparatus maximally uses the shape of the deformable body to determine the internal skeletal structure 130 of the deformable body to be modeled. The modeling apparatus obtains a virtual material property of the skeletal structure corresponding to a material property of the deformable body using a pre-computation. The modeling apparatus models the inside of the deformable body by assigning a value of the pre-computation to the material property of the skeletal structure.

In an example, the skeletal structure 130 is configured based on particles, grids, and mesh forms, such as a tetrahedron, a hexahedron, and other geometrical shapes, other than the rod frames 135 of FIG. 1. When the skeletal structure 130 is configured based on the mesh forms, the material property of the deformable body may be applied, without being changed, to the material property of the skeletal structure.

When the skeletal structure 130 is configured based on the rod frames or particles, an extra volume preservation module that enables a volume of the deformable body to be preserved is required. When the skeletal structure 130 is represented based on coarse grids structure, a physical property is obtained from a modeling method based on a finite element method (FEM).

To obtain the physical property of the deformable body, the material property corresponding to the internal skeletal structure 130 of the deformable body is obtained from the pre-computation, and then used to model the deformable body.

For instance, the modeling apparatus performs modeling based on the physical property of a motion of the coarse internal skeletal structure 130 of the deformable body, and calculates a displacement amount based on a time step. The modeling apparatus calculates displacement amounts of the surface particles 111 of the deformable body based on the displacement amount of the calculated skeletal structure 130.

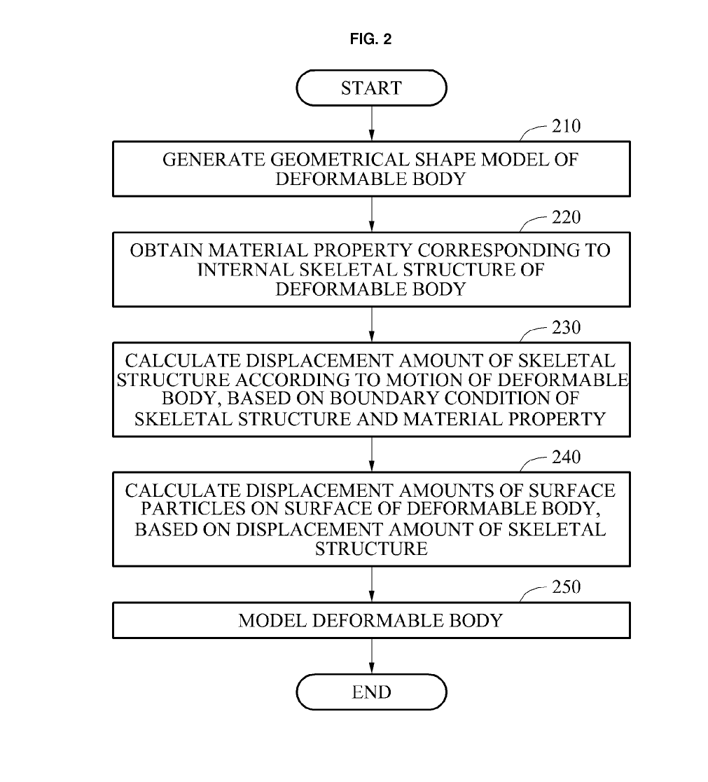

FIG. 2 is a flowchart illustrating an example of a method of modeling a deformable body, in accordance with an embodiment.

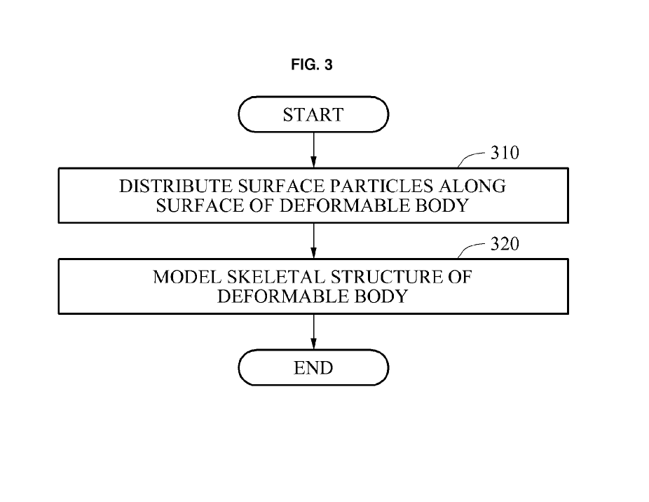

Referring to FIG. 2, in operation 210, a modeling apparatus generates a geometrical shape model of the deformable body. In operation 210, the modeling apparatus distributes surface particles on a surface of the deformable body, and coarsely models an internal skeletal structure of the deformable body. A method of generating a geometrical shape model of a deformable body using a modeling apparatus will be described with reference to FIG. 3.

In operation 220, the modeling apparatus obtains a material property corresponding to the internal skeletal structure of the deformable body modeled in operation 210.

The deformable body may have an original material property. For example, when an external force is applied to the deformable body, the material property is processed as information associated with a parameterized degree of change in a structure of the deformable body expanding or contracting in each direction based on a tensile force or a compressive force.

In operation 220, the modeling apparatus obtains a virtual material property that enables an actual material property of the deformable body to correspond to the skeletal structure of the deformable body as the material property. The material property corresponding to the skeletal structure is a value of each skeletal structural body that enables a degree of change in the deformable body according to a motion to correspond to a value, for example, a degree of change, when the skeletal structure is simplified.

When the skeletal structure of the deformable body is determined, the material property may be obtained from a pre-computation. Because the modeling apparatus models the inside of the deformable body based on the skeletal structure, the modeling apparatus obtains the material property corresponding to the internal skeletal structure of the deformable body to correspond to a material property of an actual deformable body.

In operation 230, the modeling apparatus calculates a displacement amount of the skeletal structure according to a motion of the deformable body, based on a boundary condition of the skeletal structure and the material property. The boundary condition includes a displacement boundary condition and an external force applied to the deformable body. Also, the boundary condition is obtained from an outside source of the modeling apparatus or pre-stored in a storage device.

Based on the material property obtained in operation 220, the modeling apparatus calculates a constitutive equation approximating a relationship between the displacement amount of the skeletal structure and an external force applied to the deformable body. The modeling apparatus calculates the displacement amount of the skeletal structure using the calculated constitutive equation.

The modeling apparatus enables a volume of the inside of the deformable body to be preserved when the displacement amount of the internal skeletal structure created by the external force is calculated using the constitutive equation.

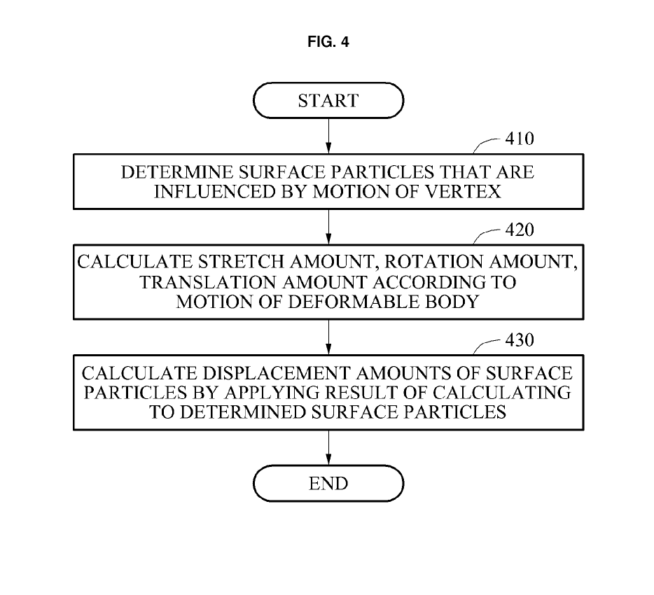

In operation 240, the modeling apparatus calculates displacement amounts of surface particles on the surface of the deformable body, based on the displacement amount of the skeletal structure calculated in operation 230. A method of calculating displacement amounts of surface particles by a modeling apparatus will be described with reference to FIG. 4.

In operation 250, the modeling apparatus models the deformable body based on the calculated displacement amounts of the surface particles.

FIG. 3 is a flowchart illustrating an example of a method of generating a geometrical shape model, in accordance with an embodiment.

Referring to FIG. 3, in operation 310, a modeling apparatus distributes surface particles along a surface of a deformable body to represent a shape of the deformable body. The modeling apparatus densely distributes the surface particles on an area in which a shape complexity is greater than or equal to a predetermined value. Further, the modeling apparatus coarsely distributes the surface particles on an area in which the complexity is less than the predetermined value.

In operation 320, the modeling apparatus models an internal skeletal structure of the deformable body. The modeling apparatus coarsely models the skeletal structure based on at least one of a frame, a mesh, a particle, and a grid.

The modeling apparatus determines a position at which the skeletal structure is to be obtained based on a curvature of the surface of deformable body. The modeling apparatus also models the skeletal structure based on the curvature of the surface of the deformable body and the shape of the deformable body. For example, the modeling apparatus models the skeletal structure by disposing frames at each end of an area in which a curvature change amount of the surface of deformable body is greater than or equal to a predetermined value.

In general, in a modeling method based on particles, to accurately model a motion of an area in which a geometrical complexity of the surface of the deformable body is high, it is difficult to significantly reduce a number of surface particles in a corresponding portion. In the case of a portion in which a number of surface particles is large, a number of particles configuring an inside of the portion may be increased.

To overcome such challenges, in accordance with an embodiment, the modeling apparatus models a single deformable body by dividing the deformable body into a surface and an inside thereof. Accordingly, the modeling apparatus reduces the number of particles configuring the deformable body, thereby enabling a reduction in the time required for modeling in real time.

FIG. 4 is a flowchart illustrating an example of a method of calculating displacement amounts of surface particles of a deformable body, in accordance with an embodiment.

Referring to FIG. 4, in operation 410, a modeling apparatus determines the surface particles that are influenced by a motion of a vertex at which structural bodies configure a skeletal structure.

In operation 420, the modeling apparatus calculates a stretch amount, a rotation amount, and a translation amount of the vertex according to a motion of the deformable body.

In operation 430, the modeling apparatus calculates the displacement amounts of the surface particles that are influenced by the motion of the deformable body by applying a result of the calculating in operation 420 to the surface particles determined in operation 410.

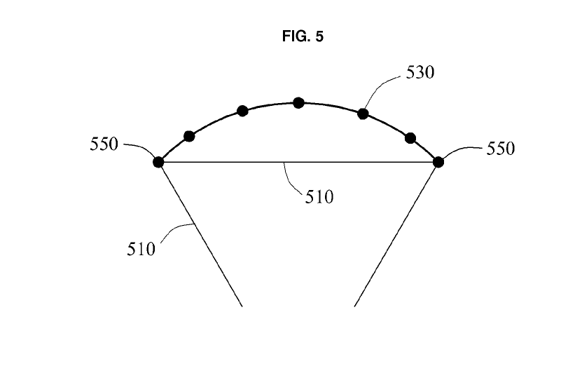

FIG. 5 is a diagram illustrating an example of a method of calculating displacement amounts of surface particles, in accordance with an embodiment.

Referring to FIG. 5, vertexes 550 of structural bodies, for example, frames 510, which configure an internal skeletal structure of deformable body, and surface particles 530 distributed along a surface of the deformable body are illustrated.

Positions of the vertexes 550 in the skeletal structure are determined based on a physical feature-based analysis, for example, a finite element method (FEM). In one illustrative example, a momentum conservation method is applied.

A modeling apparatus calculates a stretch amount, a rotation amount, and a translation amount of the frames 510 according to motions of the vertexes 550. Based on the calculation, the modeling apparatus calculates motions, for example, displacement amounts, of the surface particles 530 that are influenced by the vertexes 550.

The modeling apparatus disposes the surface particles 530 according to the motions of the vertexes 550 of an inside of the deformable body.

The modeling apparatus matches the surface particles 530 that are influenced by the vertexes 550 based on distances between the vertexes 550 and the surface particles 530. The modeling apparatus determines a virtual mass corresponding to each of the vertexes 550 by determining a group of the surface particles 530 corresponding to each of the vertexes 550 and based on the distances between the vertexes 550 and the surface particles 530. In one example, the modeling apparatus calculates displacement amounts of the surface particles 530 by applying the momentum conservation method.

The modeling apparatus arranges the internal skeletal structure of deformable body with respect to a surface shape of the deformable body based on a surface smoothing technique. For example, the modeling apparatus uses a non-uniform rational b-spline (NURBS) surface fitting method with respect to the surface of deformable body.

The modeling apparatus disposes the vertexes 550 based on a curvature of the surface of deformable body. The vertexes 550 are disposed, for example, at positions of control points of NURBS surface.

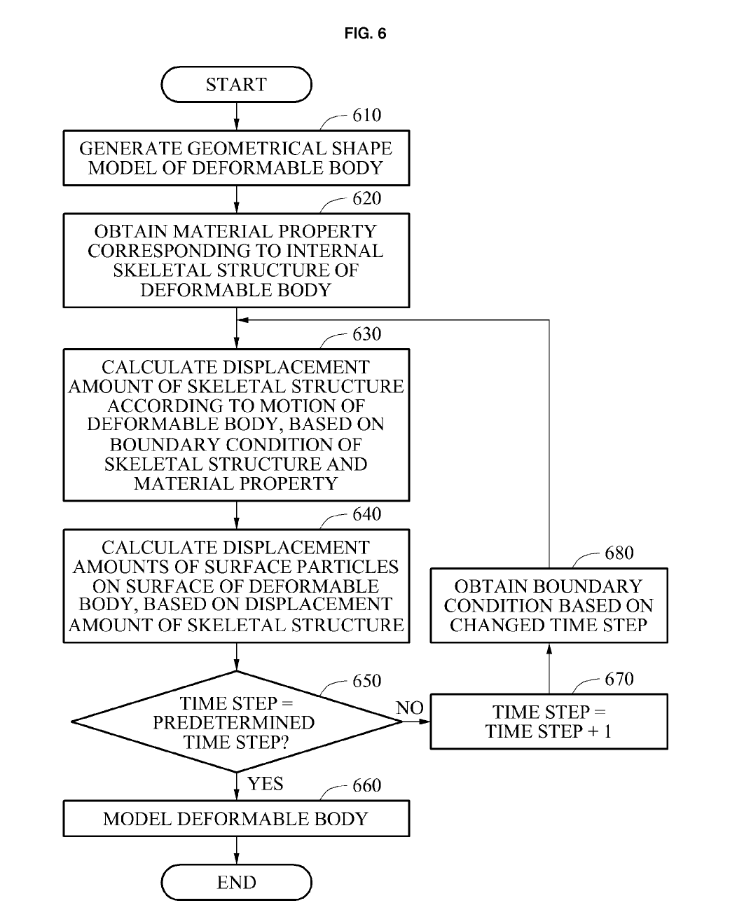

FIG. 6 is a flowchart illustrating another example of a method of modeling a deformable body, in accordance with an embodiment.

Referring to FIG. 6, in operation 610, a modeling apparatus generates a geometrical shape model of a deformable body. In operation 610, the modeling apparatus distributes surface particles along a surface of the deformable body, and coarsely models an internal skeletal structure of the deformable body.

In operation 620, the modeling apparatus obtains a material property corresponding to the internal skeletal structure of deformable body configured in operation 610. In operation 620, the modeling apparatus obtains a virtual material property that enables an actual material property of the deformable body to correspond to the skeletal structure of the deformable body as the material property.

In operation 630, the modeling apparatus calculates a displacement amount of the skeletal structure according to a motion of the deformable body, based on a boundary condition of the skeletal structure, and the material property obtained in operation 620.

Based on the material property obtained in operation 620, the modeling apparatus calculates a constitutive equation approximating a relationship between the displacement amount of the skeletal structure and an external force applied to the deformable body. The modeling apparatus calculates the displacement amount of the skeletal structure using the calculated constitutive equation.

The boundary condition includes a displacement boundary condition and the external force applied to the deformable body.

In operation 640, the modeling apparatus calculates displacement amounts of the surface particles on the surface of the deformable body based on the displacement amount of the skeletal structure calculated in operation 630. A method of calculating displacement amounts of surface particles by a modeling apparatus is described with reference to FIG. 4.

In operation 650, the modeling apparatus determines whether a time step reaches a predetermined time step. In one illustrative example, the predetermined time step is selected as an appropriate value by a user of a program or a modeling apparatus.

When the modeling apparatus determines that the time step reaches the predetermined time step in operation 650, the modeling apparatus models the deformable body based on the calculated displacement amounts of the surface particles in operation 660.

Conversely, when the time step is determined not to reach the predetermined time step in operation 650, the modeling apparatus increases one time step in operation 670 and obtains the boundary condition based on the increased, for example, changed time step in operation 680. The external force is applied at each time step, and the boundary condition changes at each time step.

The modeling apparatus iteratively performs the calculating process of the displacement amount of the skeletal structure based on the time step in operation 630 and the calculating process of the displacement amounts of the surface particles in operation 640. Until the time step reaches the predetermined time step, the modeling apparatus updates the displacement amounts of the surface particles calculated based on the displacement amount of the internal skeletal structure.

The modeling apparatus matches the displacement amount of the skeletal structure and the displacement amounts of the surface particles calculated at each time step. The modeling apparatus stores the displacement amount of the skeletal structure and the displacement amounts of the surface particles at each time step.

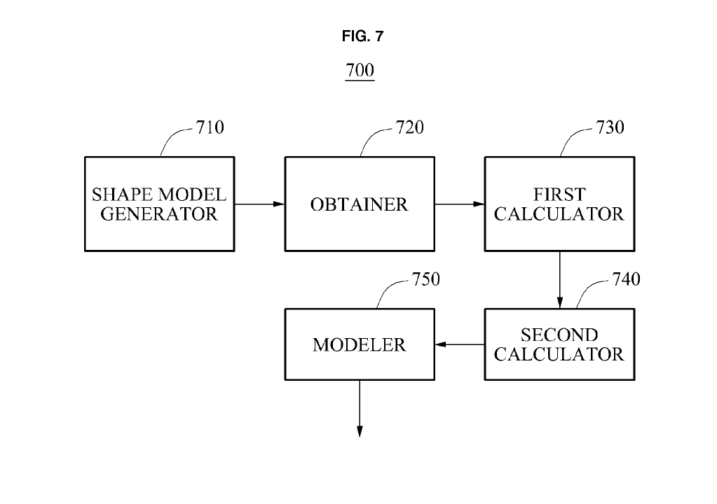

FIG. 7 is a block diagram illustrating an example of an apparatus for modeling a deformable body, in accordance with an embodiment.

Referring to FIG. 7, a modeling apparatus 700 includes a shape model generator 710, an obtainer 720, a first calculator 730, a second calculator 740, and a modeler 750.

The shape model generator 710 is configured to generate a geometrical shape model of the deformable body.

The shape model generator 710 is configured to distribute surface particles along a surface of the deformable body to represent a shape of the deformable body. The shape model generator 710 is further configured to model a skeletal structure based on a curvature of the surface of the deformable body and the shape of the deformable body.

The obtainer 720 is configured to obtain a material property corresponding to an internal skeletal structure of the deformable body. The obtainer 720 is configured to obtain a virtual material property that enables an actual material property of the deformable body to correspond to the skeletal structure of the deformable body as the material property.

The first calculator 730 is configured to calculate a displacement amount of the skeletal structure according to a motion of the deformable body, based on a boundary condition of the skeletal structure, and the material property.

The second calculator 740 is configured to calculate displacement amounts of the surface particles of the surface of the deformable body based on the displacement amount of the skeletal structure.

The second calculator 740 is also configured to determine the surface particles that are influenced by a motion of a vertex at which structural bodies configuring the skeletal structure intersect. The second calculator 740 is configured to calculate a stretch amount, a rotation amount, and a translation amount of the vertex according to the motion of the deformable body. The second calculator 740 is configured to calculate the displacement amounts of the surface particles by applying a result of the calculating to the determined surface particles.

The modeler 750 is configured to model the deformable body based on the displacement amounts of the surface particles calculated in the second calculator 740.

The modeling apparatus may further include a boundary condition obtainer (not shown) configured to obtain the boundary condition of the skeletal structure.

The apparatuses, generators, obtainers, modelers, calculators, and other components illustrated in FIG. 7 that perform the operations described herein with respect to FIGS. 1-4 and 6 are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 1-4 and 6. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-4 and 6 that perform the operations described herein with respect to FIGS. 5 and 7 are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of modeling a deformable body, the method comprising:
obtaining a material property corresponding to an internal skeletal structure of a deformable body;
calculating a displacement amount of the skeletal structure according to a motion of the deformable body, based on a boundary condition of the skeletal structure, and the material property;
calculating displacement amounts of surface particles on a surface of the deformable body, based on the displacement amount of the skeletal structure; and
modeling the deformable body based on the calculated displacement amounts of the surface particles.

2. The method of claim 1, further comprising:
generating a geometrical shape model of the deformable body.

3. The method of claim 1, further comprising:
distributing the surface particles along the surface of the deformable body to represent a shape of the deformable body; and
modeling the skeletal structure.

4. The method of claim 3, wherein the distributing comprises densely distributing the surface particles on an area in which a shape complexity is greater than or equal to a predetermined value, and coarsely distributing the surface particles on an area in which the shape complexity is less than the predetermined value.

5. The method of claim 1, wherein the modeling comprises modeling the skeletal structure based on a curvature of the surface of the deformable body and a shape of the deformable body.

6. The method of claim 5, wherein the modeling comprises modeling the skeletal structure by disposing frames at each end of an area in which a curvature change amount of the surface of the deformable body is greater than or equal to a predetermined value.

7. The method of claim 3, wherein the modeling comprises coarsely modeling the skeletal structure based on at least one of a frame, a mesh, and a particle.

8. The method of claim 1, wherein the material property comprises information on a parameterized degree of change occurring in each direction in structural bodies of a skeletal structure in response to an external force being applied to the deformable body.

9. The method of claim 1, wherein the material property is obtained from a pre-computation when the skeletal structure of the deformable body is modeled.

10. The method of claim 1, wherein the obtaining comprises obtaining a virtual material property that enables an actual material property of the deformable body to correspond to the skeletal structure of the deformable body as the material property.

11. The method of claim 1, further comprising:
obtaining a boundary condition of the skeletal structure.

12. The method of claim 11, wherein the boundary condition comprises a displacement boundary condition and an external force applied to the deformable body.

13. The method of claim 1, wherein the calculating of the displacement amount of the skeletal structure comprises:
based on the material property, calculating a constitutive equation approximating a relationship between the displacement amount of the skeletal structure and an external force applied to the deformable body; and
calculating the displacement amount of the skeletal structure using the constitutive equation.

14. The method of claim 1, wherein the calculating of the displacement amounts of the surface particles comprises:
determining surface particles that are influenced by a motion of a vertex at which structural bodies configuring the skeletal structure intersect;
calculating a stretch amount, a rotation amount, and a translation amount of the vertex according to the motion of the deformable body; and
calculating the displacement amounts of the surface particles by applying a result of the calculating to the determined surface particles.

15. The method of claim 1, wherein the modeling comprises modeling the deformable body by iteratively performing the calculating of the displacement amount of the skeletal structure and the calculating of the displacement amounts of the surface particles based on a time step.

16. A non-transitory computer-readable storage medium comprising a program, the program being configured to control a processor to perform the method of claim 1.

17. An apparatus for modeling a deformable body, the apparatus comprising:
an obtainer configured to obtain a material property corresponding to an internal skeletal structure of the deformable body;
a first calculator configured to calculate a displacement amount of the skeletal structure according to a motion of the deformable body, based on a boundary condition of the skeletal structure, and the material property;
a second calculator configured to calculate displacement amounts of surface particles of a surface of the deformable body, based on the displacement amount of the skeletal structure; and
a modeler configured to model the deformable body based on the calculated displacement amounts of the surface particles.

18. The apparatus of claim 17, further comprising:
a shape model generator configured to generate geometrical shape model of the deformable body.

19. The apparatus of claim 17, wherein the shape model generator is configured to distribute the surface particles along the surface of the deformable body to represent a shape of the deformable body, and model the skeletal structure based on a curvature of the surface of the deformable body and the shape of the deformable body.

20. The apparatus of claim 17, wherein the obtainer is configured to obtain a virtual material property that enables an actual material property of the deformable body to correspond to the skeletal structure of the deformable body as the material property.

21. The apparatus of claim 17, further comprising:
a boundary condition obtainer configured to obtain the boundary condition of the skeletal structure.

22. The apparatus of claim 17, wherein the second calculator is configured to determine surface particles that are influenced by a motion of a vertex at which structural bodies configuring the skeletal structure intersect,
calculate a stretch amount, a rotation amount, and a translation amount of the vertex according to the motion of the deformable body, and
calculate the displacement amounts of the surface particles by applying a result of the calculating to the determined surface particles.

23. The apparatus of claim 17, wherein the surface particles are densely distributed in a high geometrical complexity area comprising a curve portion.

24. The apparatus of claim 17, wherein the modeler is configured to perform modeling based on a physical property of a motion of a coarse internal skeletal structure of the deformable body, and calculate the displacement amount of the skeletal structure based on a time step.

25. The apparatus of claim 17, wherein the modeler is configured to model the skeletal structure by disposing frames at each end of an area in which a curvature change amount of the surface of deformable body is greater than or equal to a predetermined value.
